(19) United States
(12) Patent Application Publication
(10) Pub. No.: US 2022/0282980 A1
(43) Pub. Date: Sep. 8, 2022

(54) PEDESTRIAN ROUTE GUIDANCE THAT PROVIDES A SPACE BUFFER

(71) Applicant: International Business Machines Corporation, Armonk, NY (US)

(72) Inventors: Daniel James Winarski, Tucson, AZ (US); Itzhack Goldberg, Hadera (IL); Michael D. Hocker, Staatsburg, NY (US); Christopher V. DeRobertis, Hopewell Junction, NY (US); David Wayne Glass, Georgetown, KY (US); Clifford A. Pickover, Yorktown Heights, NY (US)

(21) Appl. No.: 17/190,551

(22) Filed: Mar. 3, 2021

(51) Int. Cl. G01C 21/34; G06Q 10/02; G01C 21/36

(52) U.S. Cl. CPC G01C 21/3461; G01C 21/3446; G01C 21/3423; G06Q 10/02; G01C 21/3691; H04W 4/029

(57) ABSTRACT

Aspects include detecting, at a first point in time, that a first person at a first location is within a vicinity of one or more other people and predicting, for each of the one or more people, a future location of the other person at a future point. The future point in time is subsequent to the first point in time and a confidence level is assigned to the prediction. A travel route from the first location to a destination location is generated based at least in part on the one or more predicted future locations and their assigned confidence levels. The generated travel route includes travel route locations that are more than a specified distance from at least one of the predicted future locations having an assigned confidence level greater than a confidence level threshold. Travel route guidance along the generated travel route is provided to the first person.

### BACKGROUND

The present invention relates generally to computer processing, and more specifically, to pedestrian route guidance that provides a space buffer.

### SUMMARY

Embodiments of the present invention are directed to pedestrian route guidance. A non-limiting example computer-implemented method includes detecting, at a first point in time, that a first person at a first location is within a vicinity of one or more other people and predicting, for each of the one or more people, a future location of the other person at a future point. The future point in time is subsequent to the first point in time. A confidence level is assigned to the prediction. A travel route from the first location to a destination location is generated based at least in part on the one or more predicted future locations and their assigned confidence levels. The generated travel route includes travel route locations that are more than a specified distance from at least one of the predicted future locations having an assigned confidence level greater than a confidence level threshold. Travel route guidance along the generated travel route is provided to the first person.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a system for performing pedestrian route guidance that provides a space buffer according to one or more embodiments of the present invention;

FIG. 2 depicts a flow diagram of a method for performing pedestrian route guidance that provides a space buffer according to one or more embodiments of the present invention;

FIG. 3 depicts a flow diagram of a method for reserving a destination according to one or more embodiments of the present invention;

FIG. 4 depicts a flow diagram of a method for reserving a travel route according to one or more embodiments of the present invention;

FIG. 5 depicts a block diagram of predicting future locations of people according to one or more embodiments of the present invention;

FIG. 6 depicts a block diagram of a pedestrian detection and tracking system according to one or more embodiments of the present invention;

FIG. 7 depicts a cloud computing environment according to one or more embodiments of the present invention;

FIG. 8 depicts abstraction model layers according to one or more embodiments of the present invention; and

FIG. 9 illustrates a system for providing pedestrian route guidance the provides a space buffer according to one or more embodiments of the present invention.

The diagrams depicted herein are illustrative. There can be many variations to the diagrams, or the operations described therein without departing from the spirit of the invention. For instance, the actions can be performed in a differing order or actions can be added, deleted or modified. Also, the term “coupled”, and variations thereof describe having a communications path between two elements and do not imply a direct connection between the elements with no intervening elements/connections between them. All of these variations are considered a part of the specification.

### DETAILED DESCRIPTION

One or more embodiments of the present invention are directed to providing pedestrian route guidance that includes a space buffer between a pedestrian and other people as the pedestrian moves along a travel route. One or more embodiments of the present invention include a space-time sensing of other people in the vicinity of a user walking on a street, a forecast module that predicts the location of the other people at future points in time, a route-reservation module that increases the confidence of the forecast, and a guidance module that provides guidance to the user based on weighted input from the forecast module and the route reservation module. Embodiments of the present invention can be used to assist pedestrians when they have a heightened concern about coming into contact with other people such as, but not limited to during an epidemic or pandemic, or when the person has a compromised immune system or other health issues. Variables such as, but not limited to R-naught (R0), wind speed, and disease occurrence in an area can be considered by one or more embodiments when generating the travel route.

During times of propagated outbreaks of infections, an illness may spread from person-to-person with affected individuals becoming reservoirs leading to further exposures. Reducing airborne transmission by droplet nuclei or other means can aid in slowing the spread of the infection. With the intervention of winds or drafts, the distance over which airborne infection takes place can vary. Along with wind speed, other conditions which may impact airborne transmission can be evaluated by one or more embodiments of the present invention, such as, but not limited to: confined or constrained spaces or areas where there may be elevated transmission effects; and/or physical activity which can cause increased disease particle emissions.

Many of the examples described herein have to do with pandemics and variables associated with pandemics (e.g., social distancing, R0 parameters, wind speed, comorbidities and underlying health conditions, etc.), however one skilled in the art will recognize that one or more embodiments of the present invention may be applied to other scenarios involving risk and heightened concern as a function of time and space, including but not limited to crime, pollution, health conditions, etc.

The guidance provided to users by one or more embodiments of the present invention can minimize or reduce the risk of a user catching an airborne illness by maintaining a suitable distance in space and time between the user and other users (e.g., when walking in a neighborhood). In accordance with one or more embodiments of the present invention, a route-reservation system takes into consideration travel or traversal routes booked in advanced by people (e.g., other users of the route guidance system).

The travel route guidance provided by the system described herein may include, for example, spoken directions to a user, or a graphical indication of suggested paths on a head-mounted display (HMD) or other augmented reality (AR) device. One or more embodiments may also include a “comet tail” effect influenced by movement and/environmental effects to inform the user of potential residual hazardous areas. For example, graphical or other indicators of recent nearby traversals may be helpful in mitigating risk, and the recent trails traveled may help the system to determine suitable or lower-risk routes for a user.

In accordance with one or more embodiments of the present invention, a route reservation module includes a cooperative negotiation system so that parties may negotiate in real-time as they move closer to one another. This can allow one user to be redirected on-the-fly to walk in a particular direction and traversal path to better avoid another party. Users can also increase the chances that they tend to walk in the same direction, when possible, so they are not facing one another as they pass. In addition, the route reservation module can be used to increase the chances that multiple people are not using confined spaces such as elevators or stairways at the same time.

One or more embodiments of the present invention include monitoring a plurality of individuals to determine crowd data associated with the plurality of individuals and using the crowd data to estimate a crowd pressure estimation value which indicates a likelihood of a crowd event. The term “crowd pressure” as known in the art refers to an estimation value based on the crowd density data multiplied by flow information (e.g., variance of speeds of people). The travel route guidance provided by one or more embodiments of the present invention can automatically perform at least one function (e.g., guide the user to walk a different route) when the crowd pressure estimation value exceeds a predetermined threshold value.

It is noted that a plurality of individuals who move relatively at the same speed generally are able to move to a particular destination faster than individuals moving at varying speeds. In addition, individuals moving at the same speed generally do not cause crowd events and/or do not contribute to shockwaves during crowd events. In one or more embodiments of the present invention, the variance of speeds may be used to determine the flow information of a plurality of individuals, as an indication of how efficiently the individuals are moving within a given space. For example, low variance of speeds and/or high flow rates may indicate that individuals are efficiently moving to a particular destination. In contrast, high variance of speeds and high values of crowd pressure may indicate that individuals are inefficiently moving to a particular destination or moving in a dangerous manner, with an increased likelihood of a current and/or impending crowd event. For example, if within a region of space, some individuals are moving very fast and some are moving very slow (or not moving at all), this may be indicative of a high variance of speeds.

One or more embodiments of the route guidance system described herein includes a crowd estimator to determine a crowd pressure estimation value indicative of a likelihood of a crowd event. For example, the crowd estimator may determine a crowd pressure estimation value based on the crowd density data multiplied by the flow information (e.g., variance of speeds). The crowd estimator may receive as input the crowd density information and/or variance of speed information from a camera, sensor and/or transceiver. In one or more embodiments of the present invention, the crowd estimator may detect a crowd event, and/or a likelihood of a crowd event when the crowd pressure estimation value exceeds a predetermined threshold value. For example, the predetermined threshold for the crowd pressure estimation value may include a crowd density of six (6) people per square meter and/or high variance speeds (e.g., individuals moving at significantly different speeds). What constitutes significantly different speeds can vary depending on the particular location and can be specified by a threshold such as, but not limited to a threshold that takes into consideration, for example, two people remaining stationary, three people running, and one person walking within a region of space. For example, a threshold may involve a consideration of variance, which in probability and statistics, is the expectation of the squared deviation of a random variable from its mean. Informally, this measures how far a set of numbers is spread out from their average value. The crowd density, crowd pressure, and/or density of other walkers in a region of space can by output to a user via a user interface (e.g., visual, audio, and/or haptic) of a user device.

One or more embodiments of the present invention take into account wind speed information, comorbidities and underlying health conditions, and R0 values when generating a travel route and determining a minimum space cushion between the person taking the travel route and other people. For example, wind speed may affect the dispersal of infectious particles and how far they will travel. Similarly, R0 values may be considered. R0, also referred to as the reproduction number, is a mathematical term that indicates how contagious an infectious disease is. As an infection spreads to new people, it reproduces itself. An R0 value can be used to inform the route guidance system regarding the average number of people who will catch a disease from one contagious person. It specifically applies to a population of people who were previously free of infection and haven't been vaccinated. If a disease has an R0 value of eighteen (18), a person who has the disease will transmit it to an average of 18 other people, as long as no one has been vaccinated against it or is already immune to it in their community.

The travel route generated by one or more embodiments of the present invention can be based on weighted input from the forecast module, or computer code, that predicts the future location of other people, and may also take into account wind speed, a user's comorbidities and underlying health conditions, and R0 value. Here, the term “wind speed” is also meant to optionally incorporate both speed and direction of the wind. For example, if ten (10) people are in an area, five (5) have reserved routes, the wind is at eight (8) miles per hour (mph) in the direction of the user, the user has pulmonary disease, and the R0 value is six(6) or greater, the system may direct a user to alter his/her course or delay walking for a minute or two.

Additional information can be considered by one or more embodiments of forecasting, or predicting, of future locations of people and the generating of a travel route such as, but not limited to a number of hospitalizations and deaths in an area due to the infectious disease, such as a county, town, or state. Machine learning may be employed to optimize the weighting of the different inputs to produce useful guidance to a user.

One or more embodiments of the present invention can optionally employ user profiles that users or other entities provide to the system to indicate user medical conditions, demographics, preexisting conditions, prior travel to certain areas, and so forth. This information may be used (with appropriate privacy controls) to assist the system in determining useful (e.g., relatively safe) routes, separation distances, and related travel parameters in a customizable fashion to better meet a user's needs. The profile can provide information about the user's mobility which can be used to generate a travel route For example, a person that uses a cane may have a slower rate of progression and a person that uses a wheelchair may require a route that avoid stairs or other barriers. Such profiles may also be used to allow a user to specify a degree of risk he/she desires to assume which may be different than what other users specify. For example, a six-foot separation between people may be a standard amount of space, but a particular user may have a personal preference for additional safety or may have a condition that may benefit from a ten-foot separation or from avoiding cramped stairways at certain times of the day. The user profiles of one or more embodiments of the present invention can allow the user to specify these preferences when generating a travel route for the user. For instance, a person may have diabetes and lung disease, indicated in a personal profile, and the system can provide relevant routes by attempting to change timing and directions so as to reduce risk of coming in contact with another person. Note that even if the system is unable to always maintain a “perfect” trajectory (e.g., specific separation distance between people), this approach may nevertheless reduce risk and disease spread relative to not using such a system. Simply reducing the number of possible contacts may be helpful.

In accordance with one or more embodiments of the present invention, a route reservation component includes an application, or computer program, executing on a user device for providing access to a service provider where the user (e.g., a subscriber to the service) can enroll to obtain a slot in time and space for walking from one spot, or location, to another destination spot of their choice. The service provider, executing the route guidance system may allocate the time slots as well as chart the routes for each of those people who happen to share that time slot so, that they will walk/run in safe distance from one another. One or more embodiments of the present invention can monitor the subscriber participants with reservations (e.g., using a Bluetooth or GPS device located on the user device or proximate to the user) and warn/advise any of the subscribers who violate safe distance rules (stored, for example is a database) and providing travel route guidance that includes a suggested action to be taken by the individuals to increase their distances.

It should be noted that the reservation system does not need to be used by all parties on a street, or in a mall, as it can help reduce the spread of disease even if only a relatively small percentage of individuals use the system. This reduction can arise because the system also uses a people trajectory predictor and optionally a crowd pressure predictor as described above. In accordance with one or more embodiments of the present invention, the various considerations are fused to determine a travel route and travel route guidance to the user.

One or more embodiments of the present invention may be applied to the use of escalators, elevators, stairways, and the like. For example, neighbors in a high rise building can reserve or be allotted specific times to use an elevator.

One or more embodiments of the present invention can also provide a post-travel risk assessment. For example, the number of persons encountered and the environment (e.g., a small room vs. an esplanade), the number of doorways passed though, the weather in effect (wind, still, humid, hot, sunny, etc.), and hyper-local weather that takes into account small areas of a county, for example, when such granular information is available. Using these inputs, a hazard index may be generated and output to the user or other authorized person perhaps highlighting poor choices made that could be avoided in the future to reduce the risk index.

One or more embodiments of the present invention can be utilized to provide a controlled amount of outdoor access during a pandemic, as opposed to a total lockdown. In addition, one or more embodiments of the present invention can be utilized to provide a controlled amount of access in various spaces which may be outdoors or enclosed, such as but not limited to such as shopping malls, conventions centers, sports arenas, stores, warehouses, and transportation centers.

One or more embodiments of the present invention can include additional sensing, such as carbon dioxide (CO2) levels as a proxy for exhaled disease particle density, to further refine route guidance. An embodiment may include a history profile for a route frequently followed, for instance if one path historically has a higher CO2 profile due to poor ventilation that path is not preferred over another path, or the guidance system recommends an increased traversal velocity for that area. In addition, ultraviolet (UV) levels can be taken into account as high UV levels (e.g., during the day or during a sunny day) may destroy more viruses than lower UV levels (e.g., during the night or during a rainy day).

Contemporary pedestrian route guidance systems offer pedestrian-specific maps and navigation that combine walking directions with transportation information, and they may also include routing in indoor environments. Pedestrian navigation applications are typically implemented using a standalone application running on a mobile device. For example, a user may configure an application by defining a destination. Restrictions may be applied on how to get to the destination (e.g., use of public transport) and the application guides the user using visual and audio information. Contemporary pedestrian route guidance systems are generally standalone applications running on a mobile device and they do not take into account the current locations or predicted future locations of other pedestrians. As such, contemporary systems are not geared for situations where pedestrian travelers desire to keep a space cushion, or buffer, between themselves and other pedestrian travelers (e.g., during pandemics or epidemics).

One or more embodiments of the present invention address one or more of the shortcomings of contemporary pedestrian route guidance systems by providing route guidance that takes into account a predicted future location of other pedestrian travelers when generating a travel route to provide a space cushion between the user and other pedestrian travelers. One or more embodiments of the present invention also use input from a route reservation module that increases the confidence level of the forecasted, or predicted, future locations of other pedestrians. In addition, crowed pressure can be taken into account when generating a travel route. Further, the amount of space cushion provided can vary based on factors such as, but not limited to wind speed, R0 value, comorbidities and underlying health conditions, and other values, as elucidated in this document.

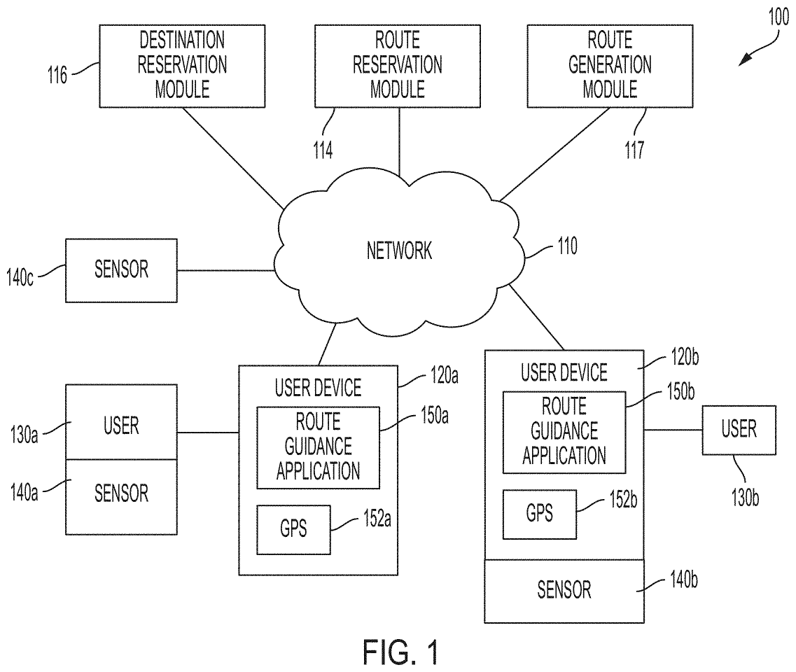

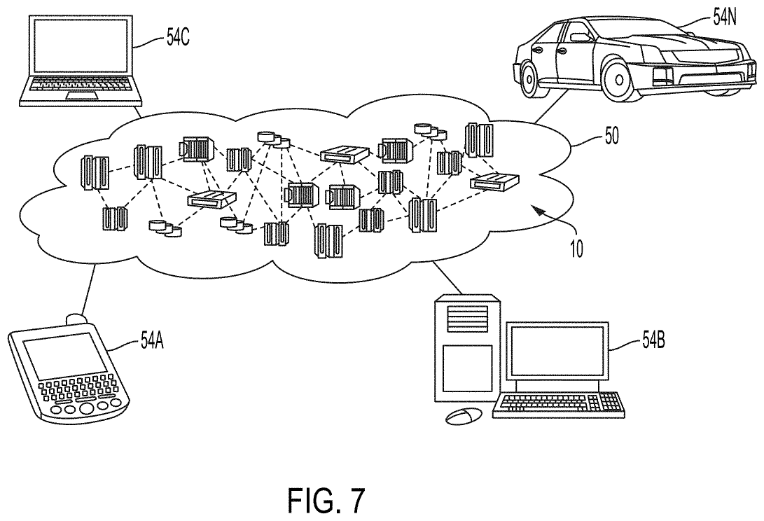

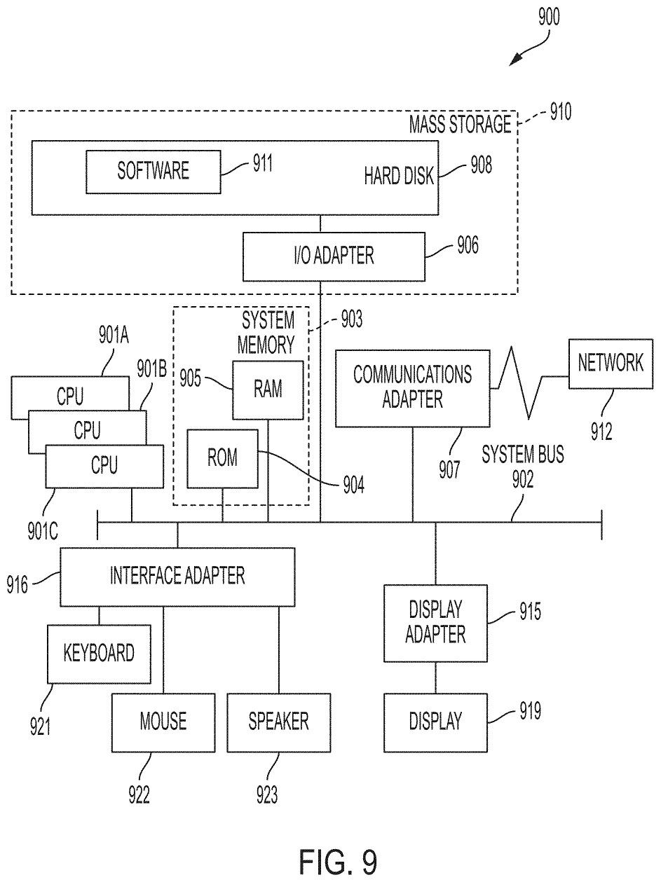

Turning now to FIG. 1, a block diagram 100 of a system for performing pedestrian route guidance that provides a space buffer is generally shown in accordance with one or more embodiments of the present invention. All or a portion of the components shown in FIG. 1 can be implemented in conjunction with any appropriate computer system, including but not limited to computer system 900 of FIG. 9 and/or a cloud computing node 10 of FIG. 7.

The components shown in the embodiment of FIG. 1 include a destination reservation module 116, a route reservation module 114, a route generation module 117, a network 110, sensors 140, users 130, and user devices 120. The destination reservation module 116, route reservation module 114, and route generation module 117 are referred to herein collectively as the route guidance system and each include computer instructions that can be implemented on the same processor or on multiple processors. In addition, the modules can communicate with each other via a direct link or via network 110. Through not shown in the FIG. 1, the route guidance system can also include a database or other storage for storing data related to the route guidance system (e.g., user profiles, maps, reservations, etc.).

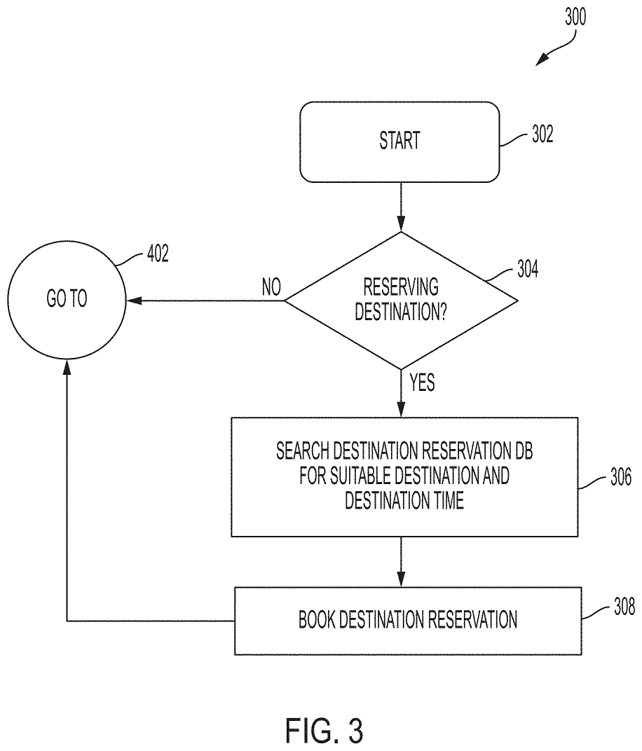

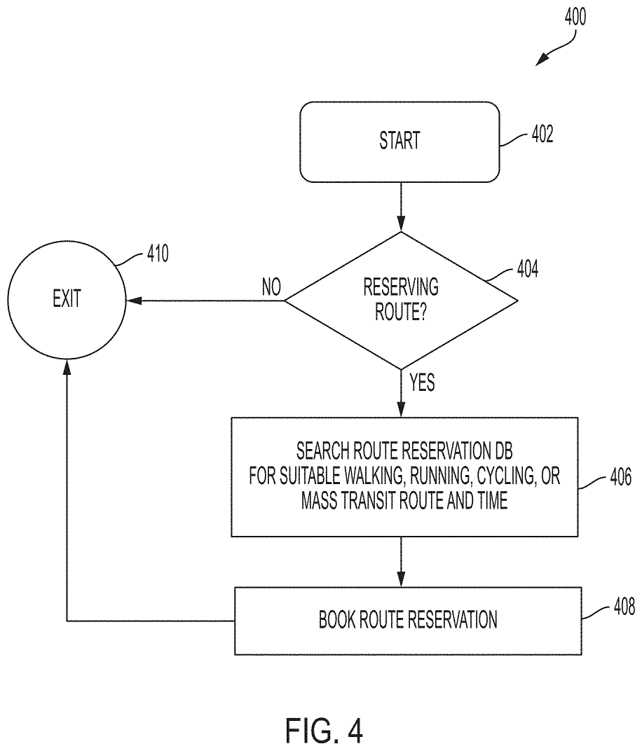

The route guidance system shown in FIG. 1 is connected to one or more user devices 120 and sensors 140 via network 110 which can be implemented using any one or more networks known in the art. In accordance with one or more embodiments of the present invention, the route guidance system is implemented by cloud computing environment 50 of FIG. 7. In accordance with one or more embodiments of the present invention, and as described further herein with respect FIG. 3, destination reservation module 116 is used to reserve a destination location. Route reservation module 114 is used by one or more embodiments of the present invention to reserve a suitable walking, running, cycling, or mass transit route and time, which may be to a reserved destination or just being outdoors (like walking the dog). This route reservation can be designed to keep the number of users at any one time within a specified distance from each other (e.g., six feet, two meters, etc.) and to avoid overcrowding on any one travel route. An embodiment of a method that can be implemented by the route reservation module 114 is shown in FIG. 4 and described below. The route generation module 117 includes computer instructions to predict future locations of other people, to generate a travel route, and to provide the travel route to a user.

Also shown in FIG. 1 are user devices 120a 120b, referred to collectively herein as user devices 120. The user devices 120 can be implemented by any device known in the art such as, but not limited to a smart phone, an Internet of Things (JOT) device such as a wheelchair or a walker or an animal collar, a virtual reality (VR) device such as a head mounted display (HMD), and/or augmented reality (AR) glasses. Each user device 120 shown in FIG. 1 includes a local route guidance application(s) 150a 150b, referred to collectively herein as route guidance application 150. In other embodiments of the present invention, all of the processing is performed by the route guidance system and the user devices 120 do not incorporate local route guidance applications 150. The local route guidance application 150 executing on a user device 120 can perform all or a subset of the processing described herein, for example, the user interface aspects and the storage of data particular to a corresponding user of the user device 120. The user devices 120 shown in FIG. 1 also include a global positioning system (GPS) device 152a 152b, referred to herein collectively as GPS device 152, for tracking a current location of the user device 120. The GPS devices 152 can also be used to track a user's compliance with the generated travel route and/or travel route guidance provided by the route guidance system.

Also shown in FIG. 1 are users 130a 130b, referred to herein collectively as users 130. Each of the users 130 has a corresponding user device 120 for accessing the route guidance system. FIG. 1 also includes sensor 140a that is proximate to or worn by user 130a, sensor 140b which is part of user device 120b, and sensor 140c which may be located anywhere in the environment of the user, such as, but not limited to on a street sign. Sensors 140a 140b and 140c are referred to herein collectively as sensors 140 and they are used by one or more embodiments of the present invention to detect the presence of one or more other users within a vicinity (e.g., a specified distance such as five feet or ten feet or twenty feet) of a user requesting a travel route. The sensors 140 can include, but are not limited to cameras, motion detectors, global positioning system (GPS) trackers and related location-based services, mobile-phone location systems, light detection and ranging (LIDAR), sonar, other inexpensive radar, passive infrared (PIR) sensors, microwave sensors, ultrasonic sensors, indoor-positioning systems (e.g., proximity-based systems, WiFi-based systems, ultra-wideband systems, acoustic systems, infrared systems), Kinect RGB-D (red, green, blue, depth) sensors, body-worn stereo cameras, and/or environmental sensors (temperature, humidity, windspeed, wind direction, sunlight intensity, UV, CO2, etc.).

For ease of description, FIG. 1 shows two user devices 120a 120b. One skilled in the art will recognize that one or more embodiments of the invention can include hundreds or thousands or tens of thousands user devices accessing route guidance system services.

The embodiments described herein with respect to block diagram 100 of FIG. 1 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

It is to be understood that the block diagram of FIG. 1 is not intended to indicate that the system is to include all of the components shown in FIG. 1. Rather, the system can include any appropriate fewer or additional components not illustrated in FIG. 1 (e.g., additional memory components, embedded controllers, functional blocks, connections between functional blocks, modules, inputs, outputs, address spaces, CPUs, virtualized container environments, container runtime environments, guest OSes, guest OS virtualization layers, authentication files, authentication handlers, containers, applications, security databases, etc.).

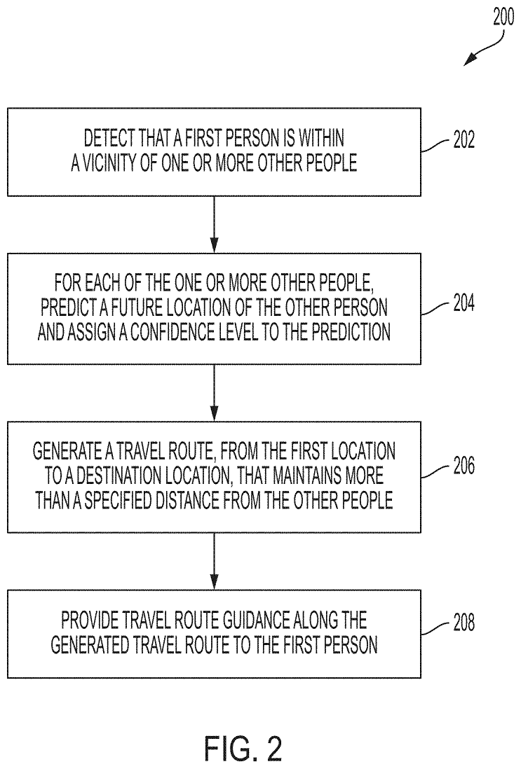

Turning now to FIG. 2, a flow diagram of a method 200 for pedestrian route guidance that provides a buffer is generally shown in accordance with one or more embodiments of the present invention. All or a portion of the processing shown in FIG. 2 can be performed, for example, by route generation module 117 of FIG. 1. In accordance with one or more embodiments of the present invention, the method 200 is initiated by a first person, such as a user 130 of FIG. 1, requesting route guidance from a first location to a destination location. The request can be made directly to the route guidance system or via a route guidance application 150 executing on a user device 120 as shown in FIG. 1.

At block 202, the system detects that the first person is at first location and within a vicinity (e.g., less than five feet away, less than ten feet away, less than 25 feet away, less than 100 feet, less than a quarter of a mile, etc.) of one or more other people. The detecting is at a first point in time, which is at or close to the current time. The location of the first person (the first location) can be determined, for example using a GPS device 152 located on a user device 120 as shown in FIG. 1. The location of the other people can be determined, for example, by one or more sensors, such as a sensor 140 of FIG. 1. The detecting can be based at least in part on output from a sensor that is worn by or proximate to (e.g., within one inch, six inches, one foot, one yard, two yards, 5 yards, etc.) the first person. In addition, or alternatively, the detecting can be based at least in part based on output from a sensor that is worn by or proximate to one or more of the other people.

At block 204 of FIG. 2, a future location of each of the one or more other people at a future point in time (i.e., that is after the first point in time) is predicted and a confidence level is assigned to the prediction. In accordance with one or more embodiments of the prevent invention, the confidence level can be increased if the other person is also a subscriber to the route guidance system and they reserved a travel route at a time that is within a time threshold of the future point in time and at least a portion of the reserved travel route is within a distance threshold of the predicted future location.

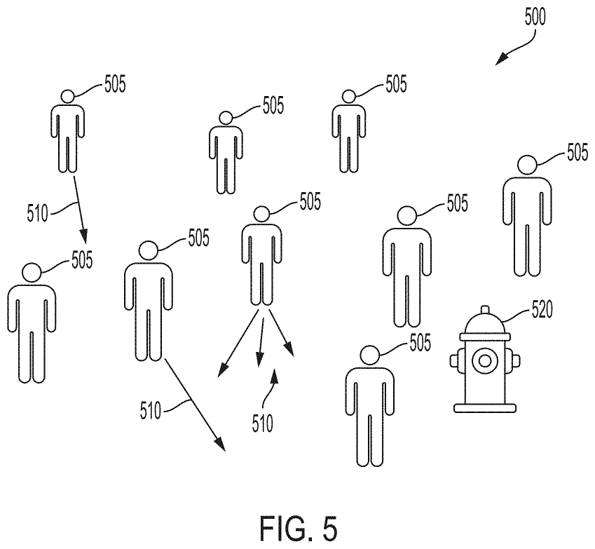

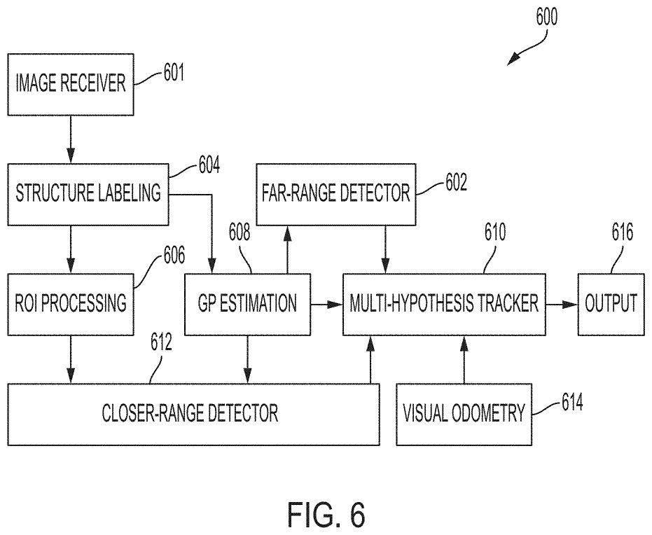

In the absence of a reservation, the predicting can be performed in any manner known in the art such as, but not limited to: input from historical crowd data including information regarding day, time of day, holidays, etc.; input from calendars (with appropriate anonymization, as needed, to preserve privacy), input from train, bus, subway, and/or taxi services; input from hotels, conference centers, sports arenas, churches, schools, and/or event planners. Examples of how to perform the predicting are shown in FIGS. 5 and 6 and are described herein below.

At block 206, a travel route is generated from the first location to a destination location based at least in part on the predicted future locations of the other people and their assigned confidence levels. The generated travel route is made up of travel route locations along the travel route that are expected to be more than a specified distance from the predicted future locations of the other people. In accordance with one or more embodiments of the present invention, only the predicted future locations having an assigned confidence level higher than a threshold value (e.g., 40%, 50%, 75%, 90%, etc.) are used when generating the travel route.

At block 208 of FIG. 2, travel route guidance along the generated travel route is provided to the first person. In accordance with one or more embodiments of the present invention, the method 200 of FIG. 2 is repeated for multiple future points in time and/or on a regular basis as the first person moves along the travel route. In this manner, one or more embodiments of the route guidance system can provide continuous or near continuous updates and the generated travel route and/or travel route guidance can be updated as the first person moves from one location to another.

For example, the generated travel route can be updated based on a crowd pressure estimation value at a particular location along the generated travel route exceeding a threshold (e.g., a variance of pedestrian speeds greater than a value), a windspeed exceeding a threshold (e.g., one mph, three mph, five mph, etc.), and/or a R0 value exceeding a threshold (e.g., R0>1). Machine learning may be employed to optimize the weighting of the different inputs to produce useful guidance to a user.

The method 200 shown in FIG. 2 includes a space-time sensing of other people in the vicinity of a user, the use of a forecast module (e.g., included in the route generation module 117 of FIG. 1) to predict the location of the other people at future points in time, with a confidence level assigned to the prediction, the use of route reservation module (e.g., route reservation module 114 of FIG. 1) to increase the confidence of the prediction, or forecast, of future locations of the other people, and a guidance module (e.g., included in the route generation module 117 of FIG. 1) that provides guidance to the user based on weighted input from the forecast module and the route reservation module.

In accordance with one or more embodiments of the present invention, the generated travel route and travel route guidance maximizes the distances in space and time between the first user and the other people based, for example on vision-based navigation systems and/or object identification and trajectory prediction (such as that employed by self-driving cars as they travel a road surrounded by people, pets, and objects).

In accordance with one or more embodiments of the present invention, the route guidance system includes a cooperative negotiation system so that parties may negotiate in real-time as they near one another, for example, so that one can on-the-fly walk in a particular direction and traversal path to better avoid other users. The cooperative negotiation can also be used to increase the chances that they tend to walk in the same direction, when possible, so they are not facing one another.

In accordance with one or more embodiments of the present invention, a crowd pressure estimation value based on crowd data is employed (e.g., as part of the predicting, or forecast module) and an ameliorative action generator is employed to automatically perform at least one function (e.g. guide the user to walk a different route) when the crowd pressure estimation value exceeds a predetermined threshold value.

In accordance with one or more embodiments of the present invention, a user interface of the user device such as a display may be used to indicate crowd density, crowd pressure, or the density of other walkers in a region of space.

In accordance with one or more embodiments of the present invention, post-processing takes place to generate a risk assessment of the path traveled by the first person. The post-processing can provide the user with an assessment of user-modulated risks taken during travel to influence the user to avoid such modulated behaviors in the future.

Aside from optionally taking into account hyper-local weather, when this information is available, to assist the guidance and forecasts modules in providing guidance, the system may also take into account transportation options in an area near the user (walking, bicycle, vehicles, public transportation, etc.).

Similarly, fuel prices may also serve as a potential predictor of “movements” and be optionally considered by one or more embodiments of the route guidance system. As the cost of fuel drops, the potential increase in “recreational” or non-optimized travel, even under pandemic conditions, may increase. This is especially true if the total numbers of places a user might visit has been dramatically reduced in quantity, but the area in which that quantity exists is much wider than what a user might have considered under normal conditions.

Utility outages, mass transportation outages or reduction in paths serviced, and closures of public gathering places can create new congestion points elsewhere as people look to find substitutes and alternatives. This kind of information may also optionally be used as additional input to the system.

Time of year, special holidays, and the like, may also be optionally considered by the forecast and guidance modules of the system, as these variables also influence forecasts of crowds, crowd densities, number of people walking outside, etc.

The process flow diagram of FIG. 2 is not intended to indicate that the operations are to be executed in any particular order, or that all of the operations shown in FIG. 2 are to be included in every case. Additionally, the processing shown in FIG. 2 can include any suitable number of additional operations.

Turning now to FIG. 3, a flow diagram of a method 300 for reserving a destination is generally shown in accordance with one or more embodiments of the present invention. All or a portion of the processing shown in FIG. 3 can be performed, for example, by the destination reservation module 116 system shown in FIG. 1. The method 300 starts at block 302 and at block 304 it is determined whether a destination location (e.g., a park, a grocery store, an elevator) needs to be reserved. In accordance with one or more embodiments, a request is received from a user, such as a user 130 of FIG. 1. The request may be via a route guidance application, such as route guidance application 150a of FIG. 1, executing on a user device, such as user device 120a of FIG. 1. As shown in the embodiment of FIG. 3, the request has come from a route generation module, such as route generation module 117 of FIG. 1, as part of generating a travel route.

If it is determined, at block 304, that a destination does not need to be reserved and the method 300 was called from a route reservation module, then processing continues at block 402 of FIG. 4. This can indicate that a route requestor does not want to reserve a destination and/or that they don't have a defined destination. This can occur when the requestor just wants to be outdoors to walk, run, bicycle, etc. and is flexible about the actual destination location.

If it is determined, at block 304, that a destination does need to be reserved, then processing continues at block 306 with searching a destination reservation database for the destination and a point in time that is close to a requested time. The destination reservation database or other suitable storage of destinations and reserved times can be located on or accessible by destination reservation module 116 of FIG. 1. An alternative destination may be substituted, or suggested, based on criteria such as availability, similarity to requested destination, proximity to requested destination, etc. For example, one grocery store may not be available but another one is. At block 308, the destination reservation is booked, or added to the destination reservation database. Processing continues at block 402 of FIG. 4.

The process flow diagram of FIG. 3 is not intended to indicate that the operations are to be executed in any particular order, or that all of the operations shown in FIG. 3 are to be included in every case. Additionally, the processing shown in FIG. 3 can include any suitable number of additional operations.

Turning now to FIG. 4, a flow diagram of a method 400 for reserving a travel route is generally shown in accordance with one or more embodiments of the present invention. All or a portion of the processing shown in FIG. 4 can be performed, for example, by the route reservation module 114 shown in FIG. 1.

The method 400 starts at block 402 and at block 404 it is determined whether a travel route (e.g., for walking, running, mass transit) needs to be reserved. In accordance with one or more embodiments, a request is received from a user, such as a user 130 of FIG. 1. The request may be via a route guidance application, such as route guidance application 150a of FIG. 1, executing on a user device, such as user device 120a of FIG. 1. As shown in the embodiment of FIG. 4, the request has come from a route generation module, such as route generation module 117 of FIG. 1, as part of or after generating a travel route.

If it is determined, at block 404, that a travel route does not need to be reserved then processing completes, or exits, at block 410. This can indicate that a route requestor does not want to reserve a destination and/or that they don't have a defined destination. This can occur when the requestor just wants to be outdoors to walk, run, bicycle, etc. and is flexible about the actual destination location.

If it is determined, at block 404, that a route does need to be reserved, then processing continues at block 406 with searching a route reservation database for the route (or for portions of the route between locations making up the route) and a point in time that is close to a requested time. The route reservation database or other suitable storage of routes and reserved times can be located on or accessible by route reservation module 114 of FIG. 1. An alternative route may be substituted, or suggested, based on criteria such as availability, similarity to requested route and/or destination, proximity to requested route, etc. The alternative route may be suggested when a threshold number of people have reserved all or a portion of the requested travel route. At block 408, the route reservation is booked, or added to the route reservation database. Processing continues with exiting at block 410.

The process flow diagram of FIG. 4 is not intended to indicate that the operations are to be executed in any particular order, or that all of the operations shown in FIG. 2 are to be included in every case. Additionally, the processing shown in FIG. 4 can include any suitable number of additional operations.

Turning now to FIG. 5, a block diagram 500 of predicting future locations of pedestrians is generally shown in accordance with one or more embodiments of the present invention. In accordance with one or more embodiments of the present invention, the route guidance system may use vision-based navigation systems in busy inner-city locations, using input from sensors mounted for example on user devices such as glasses or cell phones. In this case, semantic information can become important, and rather than modelling moving objects as arbitrary obstacles, they may be categorized and tracked in order to predict their future behavior. Classical geometric world mapping can be combined with object category detection and tracking to find instances of pedestrians, pets, and the like. Based on these detections, multi-object tracking can recover the trajectories of objects, thereby making it possible to predict their future locations, and to employ dynamic path planning. An example of this approach is shown in FIG. 5.

FIG. 5 shows a typical space with pedestrians 505, forecast trajectories (paths) 510 that they are likely to travel, and potential obstacles 520 that the pedestrians 504 may encounter that may constrain their flow. Navigation in busy urban scenarios may require category knowledge and object tracking, in order to reliably predict future scene states. Appearance-based object detection may be used by one more embodiments of the present invention. For example, two relevant object categories for street scenes include pedestrians and cars. Appearance-based object detection may deliver information such as where in the scene an object of interest is located, and what type of object it is (e.g., street furniture, fire hydrants, signs, and the like).

One or more embodiments of the present invention utilize object identification and trajectory prediction such as that used by self-driving cars or collision-avoiding robots as they travel a road surrounded by people, pets, and objects.

One or more embodiments may utilize multi-person detection and tracking systems such as those used by mobile robots and head-worn cameras or other cameras. For example, one or more embodiments of the present invention may combine RGB-D visual odometry estimation, region-of-interest processing, ground plane estimation, pedestrian detection, and multi-hypothesis tracking components into a robust vision system. Some of these kinds of computations may be performed locally while other computations may be performed on the cloud. Image receivers may include, but are not limited to, Kinect RGB-D sensors and body-worn stereo cameras.

Turning now to FIG. 6, a block diagram of a detection and tracking system 600 is generally shown in accordance with one or more embodiments of the present invention. The detection and tracking system 600 can be utilized by one or more embodiments to detect pedestrians. In accordance with one or more embodiments of the present invention, all or portions of the detection and tracking system 600 is implemented on a processor that includes a graphics processing unit (GPU) that may be executing, for example, on a remote processor such as a cloud computing node 10 of FIG. 7.

Output from the detection and tracking system 600 shown in FIG. 6 can be used by one or more embodiments of the present invention as input to predicting the future locations of pedestrians and for generating the travel route. The embodiment of the detection and tracking system 600 shown in FIG. 6 includes an image receiver 601, a structure labeling module 604, a far-range detector 602, a region of interest (ROI) processing module 606, a ground plane (GP) estimation module 608, a multi-hypothesis tracker 610, a close-range detector 612, visual odometry 614, and an output.

For each new RGB-D frame obtained by the image receiver 601, the structure labeling module 604 may be used to classify three-dimensional (3D) points into different classes (e.g., object, ground plane, and fixed structure). Fixed structure points may be filtered out. Points that are classified as ground plane are passed to the ground plane (GP) estimation module 608. Points that belong to the object class are passed to the ROI processing module 606. The ROI processing module extracts ROIs by projecting the 3D points onto the ground plane and segmenting the resulting blobs into individual objects. For each extracted 3D ROI, the system may generate a corresponding ROI in the image plane through back-projection. The two-dimensional (2D) ROIs are passed to a close-range detector 612, which may be a depth-based upper-body detector, which slides a learned upper-body template over the ROIs and computes a distance matrix containing the distances (e.g., Euclidean distances) between the template and each overlaid normalized depth image segment. The upper-body detector may operate on depth only and may be limited to the range available from depth sensors (e.g., Kinect sensors from Microsoft that detect motion), for example, up to five (5) meters.

In order to obtain detections also for pedestrians at farther ranges, the system may use a far-range detector 602, which may be ground histogram of oriented gradients (HOG) detector, or GPU optimized detector. A HOG detector can allow the system to use the estimated scene geometry GP estimation module 608 to reduce the search region in the image to the minimal region that can contain geometrically valid detections. Finally, the system may estimate the camera motion in the visual odometry 614 component. The system uses this camera motion, together with the ground plane and the detections from the far-range detector 602 and the close-range detector 612, in the multi-hypothesis tracker module 610, where bounding regions (e.g., bounding boxes) are converted to ground plane coordinates and are associated into trajectories using filters (e.g., extended Kalman filters, or “EKF”), and a multi-hypothesis handling scheme, with a consideration of pedestrian-specific motion. The system selects the subset of trajectory hypotheses (e.g., pedestrian trajectories) that best explains the observed evidence. In estimation theory, the EKF is a nonlinear version of the Kalman filter that linearizes about an estimate of the current mean and covariance.

Components of the detection and tracking system 600 may run on a smartphone, laptop, a gaming notebook, augmented reality device, smart watch, or other related device. Once an object or person's location is known, this information is provided as output 616 to the route-generation module 117, which forecasts a user's proximity to other people so that, for example, a user may avoid being within a threshold distance of another person. For example, if a person is predicted to be within 6 feet of another person at a certain point in time in the future, and R0 is greater than 1, and the wind speed is greater than 10 mph in the direction of the user, and the user has a particular comorbidity or underlying health condition, then the route-generation module 117 may alter the user's route so that the user is less likely to be within 6 feet of another person.

User comorbidities and underlying conditions can increase the danger of being exposed to pandemic and epidemic-related bacteria and viruses, and the comorbidity information may be stored in and accessed from a user profile that is encrypted. Comorbidities and underlying conditions may include, but are not limited to cancer, chronic kidney disease, pulmonary disease, heart conditions, immunocompromised state, severe obesity, pregnancy, sickle cell disease or thalassemia, diabetes, cerebrovascular disease, neurologic conditions, and liver disease. Some comorbidities may be considered more dangerous than others, and a set of rules may be used to help guide the route navigation system. For example, if user A's encrypted profile suggests she has pulmonary disease, and user B's encrypted profile says she is somewhat overweight, then user A may be more at risk and thus be routed so that she is further away from people than user B. An example rule may be: “If R0>1.3 and the user's condition is pulmonary disease, then attempt to maintain a distance of 7 feet from other people.”

Additionally, a user's profile may contain a risk aversion variable (RAV), so that if a user is particularly risk averse and desires to be especially careful (e.g., RAV=“extra careful”), a greater distance to other people may be maintained when planning routes, for example, 7 feet instead of 6 feet. The values for RAV may be stored as words or numbers (e.g., a scale from 1 to 10). Additionally, the RAV may be elaborated to specify conditions which the user considers especially hazardous and thus to be avoided, for instance perhaps the user has difficulties with stairs and thus the transit time would be greater than predicted for paths including stairs.

In accordance with one or more embodiments of the present invention, one or more of the users are equipped with inexpensive radar, LIDAR, sonar, and/or other sensing features to help estimate distances between the person and adjacent objects, whether those objects are buildings, plants, pets, or other people, and thus provide additional means for extra input to the guidance an future location predictions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

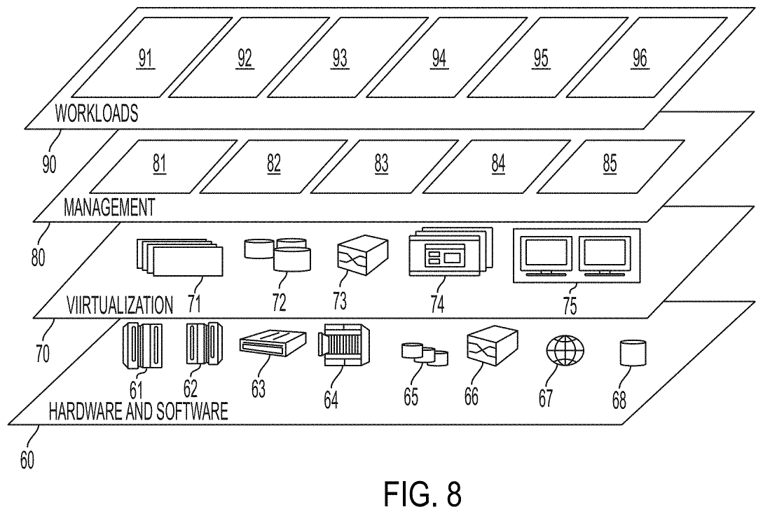

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data encryption/decryption 96.

It is understood that one or more embodiments of the present invention are capable of being implemented in conjunction with any type of computing environment now known or later developed.

Turning now to FIG. 9, a computer system 900 is generally shown in accordance with an embodiment. All or a portion of the computer system 900 shown in FIG. 9 can be implemented by one or more cloud computing nodes 10 of FIG. 7. The computer system 900 can be an electronic, computer framework comprising and/or employing any number and combination of computing devices and networks utilizing various communication technologies, as described herein. The computer system 900 can be easily scalable, extensible, and modular, with the ability to change to different services or reconfigure some features independently of others. The computer system 900 may be, for example, a server, desktop computer, laptop computer, tablet computer, or smartphone. In some examples, computer system 900 may be a cloud computing node. Computer system 900 may be described in the general context of computer system executable instructions, such as program modules, being executed by a computer system. Generally, program modules may include routines, programs, objects, components, logic, data structures, and so on that perform particular tasks or implement particular abstract data types. Computer system 900 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, the computer system 900 has one or more central processing units (CPU(s)) 901a, 901b, 901c, etc. (collectively or generically referred to as processor(s) 901). The processors 901 can be a single-core processor, multi-core processor, computing cluster, or any number of other configurations. The processors 901, also referred to as processing circuits, are coupled via a system bus 902 to a system memory 903 and various other components. The system memory 903 can include a read only memory (ROM) 904 and a random access memory (RAM) 905. The ROM 904 is coupled to the system bus 902 and may include a basic input/output system (BIOS), which controls certain basic functions of the computer system 900. The RAM is read-write memory coupled to the system bus 902 for use by the processors 901. The system memory 903 provides temporary memory space for operations of said instructions during operation. The system memory 903 can include random access memory (RAM), read only memory, flash memory, or any other suitable memory systems.

The computer system 900 comprises an input/output (I/O) adapter 906 and a communications adapter 907 coupled to the system bus 902. The I/O adapter 906 may be a serial advanced technology attachment (SATA) adapter that communicates with a hard disk 908 and/or any other similar component. The I/O adapter 906 and the hard disk 908 are collectively referred to herein as a mass storage 910.

Software 911 for execution on the computer system 900 may be stored in the mass storage 910. The mass storage 910 is an example of a tangible storage medium readable by the processors 901, where the software 911 is stored as instructions for execution by the processors 901 to cause the computer system 900 to operate, such as is described herein with respect to the various Figures. Examples of computer program product and the execution of such instruction is discussed herein in more detail. The communications adapter 907 interconnects the system bus 902 with a network 912, which may be an outside network, enabling the computer system 900 to communicate with other such systems. In one embodiment, a portion of the system memory 903 and the mass storage 910 collectively store an operating system, which may be any appropriate operating system, such as the z/OS or AIX operating system from IBM® Corporation, to coordinate the functions of the various components shown in FIG. 9.

Additional input/output devices are shown as connected to the system bus 902 via a display adapter 915 and an interface adapter 916 and. In one embodiment, the adapters 906, 907, 915, and 916 may be connected to one or more I/O buses that are connected to the system bus 902 via an intermediate bus bridge (not shown). A display 919 (e.g., a screen or a display monitor) is connected to the system bus 902 by a display adapter 915, which may include a graphics controller to improve the performance of graphics intensive applications and a video controller. A keyboard 921, a mouse 922, a speaker 923, etc. can be interconnected to the system bus 902 via the interface adapter 916, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 9, the computer system 900 includes processing capability in the form of the processors 901, and storage capability including the system memory 903 and the mass storage 910, input means such as the keyboard 921 and the mouse 922, and output capability including the speaker 923 and the display 919.

In some embodiments, the communications adapter 907 can transmit data using any suitable interface or protocol, such as the internet small computer system interface, among others. The network 912 may be a cellular network, a radio network, a wide area network (WAN), a local area network (LAN), or the Internet, among others. An external computing device may connect to the computer system 900 through the network 912. In some examples, an external computing device may be an external webserver or a cloud computing node.

It is to be understood that the block diagram of FIG. 9 is not intended to indicate that the computer system 900 is to include all of the components shown in FIG. 9. Rather, the computer system 900 can include any appropriate fewer or additional components not illustrated in FIG. 9 (e.g., additional memory components, embedded controllers, modules, additional network interfaces, etc.). Further, the embodiments described herein with respect to computer system 900 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk drive (HDD), a solid state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method comprising:
detecting, at a first point in time, that a first person at a first location is within a vicinity of one or more other people;
performing, for each of the one or more other people:
predicting a future location of the other person at a future point in time, the future point in time subsequent to the first point in time; and
assigning a confidence level to the predicting;
generating a travel route from the first location to a destination location, the generating based at least in part on the one or more predicted future locations and their assigned confidence levels, the generated travel route comprising travel route locations that are more than a specified distance from at least one of the predicted future locations having an assigned confidence level greater than a confidence level threshold; and
providing, to the first person, travel route guidance along the generated travel route.

2. The method of claim 1, wherein the performing further comprises, in response to assigning a confidence level to the predicting:
determining whether the other person has reserved a travel route at a time that is within a time threshold of the future point in time and at least a portion of the reserved travel route is within a distance threshold of the predicted future location; and
increasing the confidence level based on determining that the other person has reserved a travel route at a time that is within a time threshold of the future point in time and at least a portion of the reserved travel route is within a distance threshold of the predicted future location.

3. The method of claim 1, wherein the one or more other people comprises at least two other people.

4. The method of claim 1, further comprising repeating the performing for at least one of the one or more other people at one or more additional future points in time.

5. The method of claim 1, further comprising repeating the detecting, performing, generating, and providing as the first person moves along the generated travel route.

6. The method of claim 1, wherein the detecting is based at least in part on output from a sensor that is worn by or proximate to the first person.

7. The method of claim 1, wherein the detecting is based at least in part on output from a sensor that is worn by or proximate to at least one of the one or more other people.

8. The method of claim 1, further comprising:
receiving a crowd pressure estimation value at one or more of the travel route locations in the generated travel route; and
updating the generated travel route based on the crowd pressure estimation values exceeding a crowd pressure threshold value.

9. The method of claim 1, further comprising:
receiving a wind speed value at one or more locations along the generated travel route; and
updating the generated travel route based on the wind speed value exceeding a windspeed threshold value.

10. The method of claim 1, further comprising:
receiving one or both of a R-naught (R0) value and a disease occurrence at one or more locations along the generated travel route; and
updating the generated travel route based on one or both of the R0 value exceeding a R0 threshold value and the disease occurrence exceeding a disease occurrence threshold value.

11. The method of claim 1, further comprising:
receiving a reservation request from the first person, the reservation request comprising one or both of the travel route and the destination location; and
reserving one or both of the travel route and the destination location in response to receiving the reservation request.

12. A system comprising:
one or more processors for executing computer-readable instructions, the computer-readable instructions controlling the one or more processors to perform operations comprising:
detecting, at a first point in time, that a first person at a first location is within a vicinity of one or more other people;
performing, for each of the one or more other people:
predicting a future location of the other person at a future point in time, the future point in time subsequent to the first point in time; and
assigning a confidence level to the predicting;
generating a travel route from the first location to a destination location, the generating based at least in part on the one or more predicted future locations and their assigned confidence levels, the generated travel route comprising travel route locations that are more than a specified distance from at least one of the predicted future locations having an assigned confidence level greater than a confidence level threshold; and
providing, to the first person, travel route guidance along the generated travel route.

13. The system of claim 12, wherein the performing further comprises, in response to assigning a confidence level to the predicting:
determining whether the other person has reserved a travel route at a time that is within a time threshold of the future point in time and at least a portion of the reserved travel route is within a distance threshold of the predicted future location; and
increasing the confidence level based on determining that the other person has reserved a travel route at a time that is within a time threshold of the future point in time and at least a portion of the reserved travel route is within a distance threshold of the predicted future location.

14. The system of claim 12, wherein the one or more other people comprises at least two other people.

15. The system of claim 12, wherein the operations further comprise repeating the performing for at least one of the one or more other people at one or more additional future points in time.

16. The system of claim 12, wherein the operations further comprise repeating the detecting, performing, generating, and providing as the first person moves along the generated travel route.

17. The system of claim 12, wherein the detecting is based at least in part on one or both of output from a sensor that is worn by or proximate to the first person and output from a sensor that is worn by or proximate to at least one of the one or more other people.

18. The system of claim 12, wherein the operations further comprise:
receiving a crowd pressure estimation value at one or more of the travel route locations in the generated travel route; and
updating the generated travel route based on the crowd pressure estimation values exceeding a crowd pressure threshold value.

19. The system of claim 12, wherein the operations further comprise:
receiving a wind speed value at one or more locations along the generated travel route; and
updating the generated travel route based on the wind speed value exceeding a windspeed threshold value.

20. A computer program product comprising a computer-readable storage medium having program instructions embodied therewith, the program instructions executable by one or more processors to cause the one or more processors to perform operations comprising:
one or more processors for executing computer-readable instructions, the computer-readable instructions controlling the one or more processors to perform operations comprising:
detecting, at a first point in time, that a first person at a first location is within a vicinity of one or more other people;
performing, for each of the one or more other people:
predicting a future location of the other person at a future point in time, the future point in time subsequent to the first point in time; and
assigning a confidence level to the predicting;
generating a travel route from the first location to a destination location, the generating based at least in part on the one or more predicted future locations and their assigned confidence levels, the generated travel route comprising travel route locations that are more than a specified distance from at least one of the predicted future locations having an assigned confidence level greater than a confidence level threshold; and
providing, to the first person, travel route guidance along the generated travel route.
